(19) United States
(12) Patent Application Publication
(10) Pub. No.: US 2003/0049182 A1
(43) Pub. Date: Mar. 13, 2003

(54) System and method for abatement of dangerous substances from a waste gas stream

(76) Inventors: Christopher Hertzler, San Jose, CA (US); Phuc Pham, San Jose, CA (US)

Correspondence Address: HICKMAN PALERMO TRUONG & BECKER, LLP, 1600 WILLOW STREET, SAN JOSE, CA, 95125, US

(21) Appl. No.: 10/274,325

(22) Filed: Oct. 17, 2002

Related U.S. Application Data
(63) Continuation-in-part of application No. 09/846,495, filed on Apr. 30, 2001.
(60) Provisional application No. 60/200,959, filed on May 1, 2000.
(60) Provisional application No. 60/347,616, filed on Oct. 26, 2001.

(51) Int. Cl. B01D 50/00; B01D 53/34; B01D 53/00

(52) U.S. Cl. 422/168; 422/169; 422/170; 422/171

(57) ABSTRACT

A system for abating dangerous substances, for example, from a semiconductor fabrication process tool, comprises a thermal oxidation unit configured to accept a waste gas stream, a particulate remover directly coupled to the thermal oxidation unit, a universal sump chassis directly coupled to the particulate remover, a packed column directly coupled to the universal sump chassis, and a dry scrub canister coupled to the packed column. An embodiment includes multiple parallel components, that is, two or more thermal oxidation units, each configured to accept a different waste gas stream which may be combustible when mixed, two or more particulate removers and two or more packed columns, each directly coupled to the universal sump chassis. A method comprises, first, oxidizing combustible substances; second, removing particulate-phase and water-soluble gas-phase components; third, absorbing acid gases; and last, adsorbing residual contaminants.

### CROSS-REFERENCE TO RELATED APPLICATIONS

This application is a continuation-in-part of and claims benefit of domestic priority under 35 U.S.C. §120 from commonly-assigned U.S. patent application Ser. No. 09/846,495 entitled “Treatment System for Removing Hazardous Substances From a Semiconductor Process Waste Gas Stream,” filed on Apr. 30, 2001, which claims priority to U.S. Provisional Patent Application No. 60/200,959, filed on May 1, 2000; and is related to and claims benefit of domestic priority under 35 U.S.C. §119 from U.S. Provisional Patent Application No. 60/347,616 entitled “System and Method for Abatement of Dangerous Substances From a Waste Gas Stream,” filed on Oct. 26, 2001; all of the contents of which are incorporated by reference herein in their entirety for all purposes, as if fully set forth herein.

### FIELD OF THE INVENTION

The present invention relates generally to waste treatment and, more specifically, to abatement of dangerous substances from a semiconductor process waste gas stream.

### BACKGROUND OF THE INVENTION

Semiconductor fabrication processes, such as chemical vapor deposition (CVD), utilize several chemicals that are highly toxic, corrosive, flammable, pyrophoric, or otherwise dangerous. Typically, the process consumes only small portions of the chemicals. The unconsumed chemicals, together with particulate-phase reaction products, exit the processing equipment as a waste gas stream and flow into an exhaust system. Because certain components of the waste gas stream possess dangerous or noxious properties, it is desirable and/or legally required to treat the waste gas stream prior to discharge to the atmosphere to eliminate or minimize discharge of the objectionable waste gas components.

A number of commercially available waste gas treatment systems are available for removing selected gas-phase and solid-phase substances from a waste gas stream. One such system is described in U.S. Pat. No. 5,295,448 entitled “Organic Compound Incinerator”. Other systems for removing volatile organic compounds (VOCs) from a gas stream are described in the following patents: U.S. Pat. No. 5,538,541 entitled “Apparatus and Method for Removing Volatile Organic Compounds From An Air Stream”; U.S. Pat. No. 5,667,559 entitled “Apparatus and Method for Removing Volatile Organic Compounds From An Air Stream”; and U.S. Pat. No. 6,027,550 entitled “Apparatus and Method for Removing Volatile Organic Compounds From A Stream of Contaminated Air With Use of An Adsorbent Material”.

Due to relatively high particulate loading and to the corrosive nature of waste gas streams associated with semiconductor fabrication processes, users of prior waste gas treatment systems often experience problems with clogging of the gas flow path and component wear. Remediation of these problems, for example, removal of accumulated particulate matter or replacement of corroded components, frequently necessitates temporary shutdown of the associated fabrication process equipment, causing unscheduled and undesired downtime. Such unscheduled maintenance time increases overall manufacturing costs and, hence, is particularly problematic in the highly competitive and price-driven semiconductor fabrication industry. Therefore, users of prior treatment systems are required to choose between abatement efficiency and treatment system downtime.

Fluorine is a significantly poisonous gas, which can cause death at single digit parts-per-million (ppm). Therefore, it is desirous and often legally required to eliminate fluorine, as well as other acid gases, from waste gas streams prior to discharge to the atmosphere. Generally, in prior waste gas treatment systems, in order to get acid gases to required low levels, either relatively large amounts of fresh water is needed or residual components such as fluorine need to be processed with a secondary wet scrubbing unit. Neither of these alternatives is considered optimal.

PFCs, such as CF₄ (otherwise known as Freon R14) and C₂F₆ (otherwise known as Freon R116), are considered ozone-depleting, global-warming substances. Therefore, it is desirous and often legally required to eliminate such substances from a waste gas stream prior to discharge to the atmosphere. Furthermore, PFCs are generally associated with relatively high combustion temperatures. For example, CF₄ begins to combust at approximately 1100° C. Generally, prior waste gas treatment systems either cannot reach the temperatures necessary to fully combust many PFC substances, or they rely on open flame to reach the necessary temperatures, thus increasing the risk of an undesired explosion within the treatment system.

Based on the foregoing, it is clearly desirable to provide an improved mechanism for treatment of waste gas streams, such as waste gas streams associated with semiconductor fabrication processes.

Furthermore, there is a need for an efficient, reliable system for abating a wide variety of dangerous substances from a waste gas stream, with consideration to the chemical compounds constituent to a typical semiconductor waste gas stream, and the compounds that exist at all stages of a waste gas treatment system. Particularly, there is a need for a single device that provides abatement of the following pollutant classes: flammables, pyrophorics, fluorine compounds, PFCs, VOCs, acid gases, hydrides and other semiconductor chamber clean gases.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of a system for abating dangerous substances from a waste gas stream; and

FIG. 2 is a flowchart illustrating a process for abating dangerous substances from a waste gas stream.

### DETAILED DESCRIPTION

Systems and methods are described for abatement of dangerous substances from a waste gas stream. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

A system for abating dangerous substances from a waste gas stream comprises (1) a thermal oxidation unit configured to accept a waste gas stream; (2) a particulate remover, such as a wet scrubber unit, directly coupled to the oxidation unit; (3) a universal sump chassis coupled to the particulate remover and to (4) a packed column; and (5) a dry scrub canister coupled to the packed column, thereby providing abatement of residual chemical compositions found in the waste gas stream.

The unique functions of each of these treatment stages, with respect to abatement of particular gas-phase and solid-phase components of a waste gas stream, are linked together to provide a highly destruction-efficient process for comprehensive destruction of target compounds found in the waste gas stream. For non-limiting examples of possible implementations, embodiments can be utilized for semiconductor chemical vapor deposition process abatement and semiconductor etching process abatement, to provide abatement of the following pollutant classes: flammables, pyrophorics, fluorine compounds, PFCs, VOCs, acid gases, and hydrides.

In one aspect, the system is implemented in a parallel configuration that can accept separate and independent gas streams, for example, from a two-stage semiconductor fabrication tool. In addition, the two gas streams may be highly reactive with each other, that is, they may be highly combustible or explosive as a mixed compound. The configuration of the system ensures no mixing of streams until explosive components have been sufficiently altered or eliminated.

In an embodiment, the thermal oxidation unit is electrically heated and can operate up to 1200° C. Operation in this temperature regime provides for destruction of ozone-depleting substances, for example, perfluorinated carbon compounds (PFCs) such as CF₄. Furthermore, the preceding is accomplished with a significantly reduced risk of inadvertent combustion within the system, which is often encountered in gas-heated systems.

### Abatement System

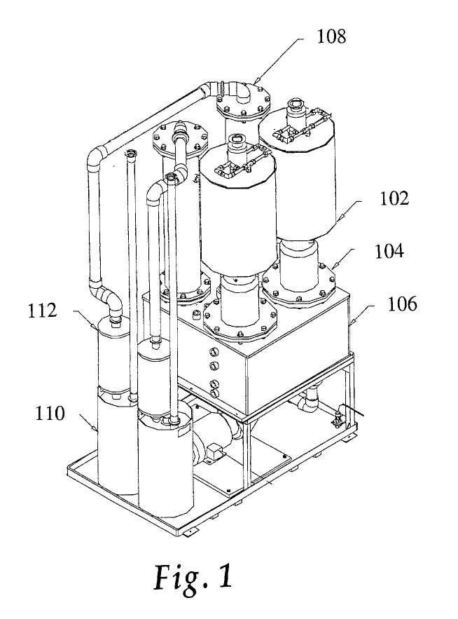

FIG. 1 is an illustration of a system 100 for abating dangerous substances from a waste gas stream. The system 100 comprises one or more thermal oxidation units 102, one or more particulate remover units 104, a universal sump chassis 106, one or more packed columns 108, and one or more dry scrub canisters 110. Furthermore, system 100 may include one or more optional filters 112 between a packed column 108 and a dry scrub canister 110.

According to an embodiment, and as depicted in FIG. 1, system 100 comprises two parallel thermal oxidation units 102, two particulate removers 104, two packed columns 108, two dry scrub canisters 110 and two filters 112. However, the number of each component may vary from implementation to implementation.

### Thermal Oxidation Unit

Thermal oxidation unit 102 is configured to accept a waste gas stream through an inlet. In an embodiment, the waste gas stream is a semiconductor process waste gas stream, such as from a semiconductor fabrication tool. In an embodiment that comprises two or more parallel thermal oxidation units 102, each unit 102 is configured to accept a different waste gas stream. For example, some semiconductor fabrication tools comprise two separate chambers that perform separate fabrication processes, such as a chemical vapor deposition (CVD) process and an etching process, each of which emits a different waste gas stream. In some situations, the two waste gas streams that are emitted from the fabrication tool are combustible when mixed. For example, a process may emit NF₃, which is considered an oxidizer, and SiH₄ (silane), a pyrophoric. Hence, in an embodiment in which two thermal oxidation units 102 are employed, a first unit 102 is configured to accept a first waste gas stream comprising a first gas and a second unit 102 is configured to accept a second waste gas stream comprising a second gas, wherein the first and second gases are combustible when mixed.

The first step of an abatement process that utilizes the system 100, is thermal oxidation of one or more waste gas streams in respective thermal oxidation units 102. Inside the thermal oxidation unit 102, the waste gas stream is mixed with an oxidizing gas stream which is injected into the unit 102 by way of a oxidizing gas inlet. The oxidizing gas stream, which may include air or an air/oxygen mixture, is injected into the waste gas stream at high pressure to induce turbulence and, consequently, to promote rapid mixing of the waste gas stream and oxidizing stream inside the unit 102. The oxidizing gas stream also aids in keeping condensable solids present in the waste gas stream in a gaseous phase until they are removed. Furthermore, the type and amount of oxidizing gas added to the waste gas stream can be adjusted based on the composition of the waste gas and/or based on particular abatement requirements.

The mixture of waste gas and oxidizing gas is passed through a high-temperature reaction zone inside thermal oxidation unit 102, where PFCs, pyrophoric, and flammable components of the waste gas stream are combusted. In an embodiment, thermal oxidation unit 102 comprises one or more electric heaters. For example, a conventional radiative ceramic resistance heater, or a suitable alternative, may be implemented.

In another embodiment, thermal oxidation unit 102 comprises a super-alloy metal tube through which the waste gas stream passes, enshrouded by one or more electric heaters. In this context, the term “super-alloy” refers to heat-resistant and corrosion-resistant metals. Examples of alloys that may be chosen for such implementations include nickel-based metals, some of which are available from Special Metals Corporation and sold under the trade names INCONEL®, INCOLAY®, NIMONIC®, and MONEL®, or available from Haynes International and sold under the trade names HAYNES® and HASTELLOY®. One such metal that may be used is INCONEL® 601.

Due to the composition of metals employed at various locations in the thermal oxidation unit, the surface of the super-alloy metal tube, and thus the thermal oxidation unit 102, is capable of operating at temperatures up to 1200° C. Operating at such a high temperature allows the destruction of ozone-depleting, global warming substances, such as perfluorinated carbons (PFCs). For example, combustion of CF₄ begins at around 1100° C. Operating at temperatures up to 1200° C. with an electric heater is significantly beneficial, for users are increasingly reluctant to employ, indeed, some prohibit, gas-fired (e.g., methane) oxidation units due to risks of catastrophic explosion.

In addition, metals for implementation within the thermal oxidation unit 102 can be chosen to provide adequate corrosion-resistance, even in the presence of highly corrosive fluorine. Furthermore, the dimensions selected for the super-alloy tube of thermal oxidation unit 102 are preferably selected to provide adequate reaction time for oxidation of silane and other toxic gases to be substantially completed, while maintaining gas velocity sufficiently high to minimize deposition of particulates on the inner wall of the tube.

In general, selection of metals at various stages of the abatement system 100 may be based on different environmental conditions present at various stages of the system 100. For example, a different metal may be chosen for a hot gaseous zone, such as in thermal oxidation unit 102, than for a cold wetted zone, such as in particulate remover 104.

An example of an apparatus that could be implemented into system 100 as a thermal oxidation unit is described in U.S. Pat. No. 5,295,448 entitled “Organic Compound Incinerator”, which is incorporated by reference herein in its entirety for all purposes, as if fully set forth herein.

### Particulate Remover

Particulate remover 104 is used for the second stage of the abatement process provided by the abatement system 100. An example of a particulate remover 104 is a device that is commonly referred to as a wet scrubber. For example, a high temperature vortex scrubber (HTVS), available from TecHarmonic, Inc., may be used as a particulate remover 104; however, embodiments are not limited to use of the particular referenced particulate remover 104. A suitable particulate remover 104 is described in U.S. patent application Ser. No. 09/846,495, entitled “Treatment System For Removing Hazardous Substances From a Semiconductor Process Waste Gas Stream”.

The particulate remover 104 is directly coupled to the thermal oxidation unit 102. Due to a direct coupling between particulate remover 104 and oxidation unit 102, that is, a coupling without an adjoining pipe, the probability of clogging of the system 100 is significantly reduced. In the embodiment in which two or more thermal oxidation units 102 are implemented, similarly, respective two or more particulate removers 104 are directly coupled thereto.

Particulate remover 104 operates to remove particulate-phase components of the waste gas stream along with a portion of the highly water-soluble gas-phase components, such as hydrogen fluoride (HF). The waste gas stream passing through the particulate remover 104 comprises particulate-phase components from both the process tool (e.g., semiconductor fabrication process tool) and from combustion of substances in the thermal oxidation unit 102. Furthermore, particulate remover 104 functions to create a vortex within thermal oxidation unit 102. Hence, particulate remover 104 contributes to cooling the waste gas stream, which is heated to an elevated temperature inside thermal oxidation unit 102, and assists in mixing the oxidizing and waste gases within thermal oxidation unit 102.

### Universal Sump Chassis

Particulate remover 104 discharges gaseous and liquid waste with entrained solids to a common sump, such as universal sump chassis 106, which is directly coupled to the particulate remover 104. In an implementation of system 100 that comprises a plurality of particulate removers 104, any number of the plurality of particulate removers 104, preferably all of them, can be directly coupled to the universal sump chassis 106. Similarly, in an implementation of system 100 that comprises a plurality of packed columns 108, any number of the plurality of packed columns 106, preferably all of them, can be directly coupled to the universal pump chassis 106. Hence, the plurality of packed columns 108 would operate as a single device.

The particulate remover 104 can be coupled to the sump chassis 106 such that the lower end of the particulate remover is substantially flush with the upper face of the sump chassis 106, or such that the lower end of the particulate remover extends partially past the upper face of and into the body of the sump chassis 106. Consequently, there is no adjoining plumbing that is at risk for clogging. Furthermore, the sump chassis 106 can be directly coupled to one or more packed columns 108 without adjoining plumbing at risk for clogging.

In use, the sump chassis 106 contains water or some other suitable liquid, which is substantially maintained at a particular level within the sump chassis 106. The water content within the sump chassis 106 fluctuates in composition due to portions continuously being purged, recirculated, and replenished with fresh water. A portion of the water is purged to remove a portion of the particulates from the previous stages. The portion of the water that is recirculated, although not completely “clean”, still has significant cleaning capacity and is recirculated throughout the system, primarily to the particulate remover 102 and/or the packed column 108. Hence, user demands with respect to water consumption of the system 100, which are typically strict, are met through the water recirculation and control process. In addition, water vapor within sump chassis 106 rises into and through the particulate remover 104 and into thermal oxidation unit 102, thereby aiding the reaction processes, particularly in thermal oxidation unit 102.

The waste gas within the universal sump chassis 106 migrates across the surface of the water within the sump chassis 106 to the packed column 108, which contributes to abatement of dangerous substances from the waste gas. Furthermore, implementations may use plastic or metal versions of the sump chassis 106, whereby the metal versions further contribute to cooling of the water.

In an embodiment, the universal sump chassis 106 is configured with a substantially horizontal interstitial member, i.e., a false floor. The horizontal member functions as an integrated heat exchanger, being configured to separate the waste water from cooling water being pumped into a cavity underneath the horizontal member, thereby further contributing to cooling of the waste water and the waste gas.

An embodiment was previously described in which a plurality of thermal oxidation units 102 and particulate removers 104 are employed in the system 100, whereby each oxidation unit 102 accepts a separate waste gas stream which might be combustible upon mixing. In such an embodiment, the separate waste gas streams are mixed within the universal pump chassis 106, at a point in the abatement process where the risk of combustibility is significantly, if not completely, reduced due to the change in composition of the respective original waste gas streams.

### Packed Column

One or more packed columns 108 are directly coupled to the universal sump chassis 106. As a result of a direct coupling, that is, without adjoining plumbing, less risk of clogging is present. A packed column 108 absorbs gases to water, causing the mass transfer of toxic and corrosive substances from the waste gas stream to a water stream. The toxins can then be removed by way of precipitation, external to the packed column 108. Packed column 108 preferably uses a water spray, introduced at an upper area of the column 108 and traveling downwardly. The water spray interacts with the waste gas stream, which is introduced at a lower area of the column 108 and flows upwardly.

Packed column 108 contains packing material, such as alumina ceramic or some other ceramic-based material, stainless steel, Teflon, or polypropylene. As the water flows downwardly through the packing material, it absorbs acid gases such as hydrogen fluoride from the waste gas stream. Further, the water can absorb particulate matter not previously removed from the waste gas stream at other stages of the system 100.

System 100 can be equipped with more than one packed column 108, each directly coupled to the universal sump chassis 106. As such, the plurality of packed columns 108 receive waste gas effluent from each particulate remover 104, which is mixed within sump chassis 106 and passively distributed to the packed columns 108. In this configuration, the plurality of packed columns 108 function as a single unit.

### Dry Scrubber

The waste gas stream travels from one or more packed columns 108 to a dry scrub canister 110. System 100 may be configured with one or more p-traps and/or filters to dry the waste gas stream prior to entry to dry scrub canister 110. As depicted in FIG. 1, system 100 may include one or more optional filters 112, such as a demister.

In a configuration in which there are multiple packed columns 108, the gases exiting packed columns 108 may be combined and then passed through a single filter 112 or multiple filters 112 configured in series, before entering one or more dry scrub canisters 110. Alternatively, the gases exiting packed column 108 may not be combined before entering respective filters 112 or dry scrub canisters 110, but each gas path from a packed column 108 to a dry scrub canister 110 may be independent of the other similar gas path. Furthermore, in a configuration in which there are two or more dry scrub canisters 110, the gases exiting packed columns 108 or filters 112 may be combined and enter through a single inlet to two or more dry scrub canisters 110 in series. Alternatively, each gas path exiting packed columns 108 or filters 112 may be independent of the other similar gas path, with each passing through respective parallel dry scrub canisters 110.

Dry scrub canister 110 contains an adsorbent resin to provide a high level of removal of minute residual contaminates that are not abated to a desired level of efficiency through thermal oxidation or particulate removal. Significantly, rather than continuously circulating a large amount of fresh water through system 100 or sending the waste gas stream exiting packed column 108 back through particulate remover 104, neither of which are optimal or desired, dry scrub canister 110 is configured after packed column 108 in system 100. Furthermore, as a result of its location in the system 100 after the thermal oxidation unit 102, particulate remover 104 and packed column 108, dry scrub canister 110 will experience an increased lifetime and increased efficiency in relation to a stand-alone dry scrubber.

According to an embodiment, a portion of the gas stream exiting dry scrub canister 110 is recirculated back to thermal oxidation unit 102 and the rest of system 100, resulting in a significant increase in system 100 efficiency in abatement of dangerous substances.

### Process for Abating Dangerous Substances from a Waste Gas Stream

Configuring an abatement system such as system 100 to efficiently and effectively abate waste gas streams with a high content of toxic and corrosive substances, such as waste gas streams coming from semiconductor fabrication process tools, necessitates a high degree of understanding of the content, state and characteristics of the waste gas entering system 100 as well as the waste gas stream at all points as it moves through system 100. Such a degree of understanding comes from practical field-based experience in testing and analysis of the gases. For example, testing furthers discovery of how CF₄ reacts at 1200 C without an open flame. Therefore, the knowledge that is gained by testing and analysis of the content, state and characteristics of gases at various stages of system 100 results in a system that accepts highly toxic and corrosive substances and abates them to a degree that the gas output from the system 100 is safely breathable.

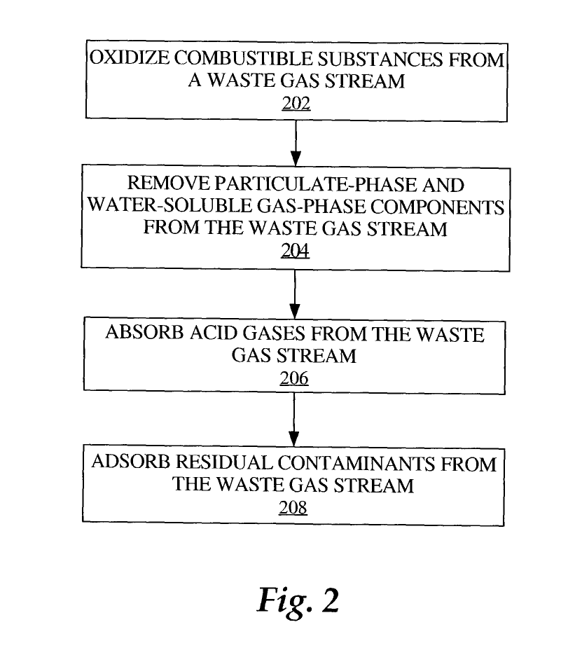

FIG. 2 is a flowchart illustrating a process for abating dangerous substances from a waste gas stream. An example of the process, with respect to the chemical reactions that occur during the process of abating a typical semiconductor fabrication tool waste gas, follows.

At block 202, combustible substances in an input waste gas stream are oxidized. For example, common stages of a semiconductor fabrication process involve layering and/or etching of the semiconductor. Thus, a typical input gas stream to the abatement process contains hydrogen (H₂), tungsten tetrafluoride (WF₆), silane (SiH₄), and perfluorinated carbons (PFCs) such as CF₄ (for etching process). Processing the gas stream according to block 202, that is, through use of thermal oxidation unit 102 (FIG. 1), burns the hydrogen, most of the PFCs, and the silane, which creates an amount of silicon dioxide, or sand. The tungsten compound is relatively unabated.

At block 204, particulate-phase and water-soluble gas-phase components of the gas stream are removed, for example, through use of particulate remover 104 (FIG. 1). Returning to the example, a vortex within particulate remover 104 separates and removes the sand, and the tungsten compound immediately bursts into tungsten oxides in the presence of water, which are subsequently removed. The fluorine and hydrogen fluoride (HF) travel on to the next stage.

At block 206, acid gases are absorbed using a packed column, such as packed column 108 (FIG. 1). Returning to the example, fluorine and hydrogen fluoride are absorbed by the water in packed column 108.

Finally, at block 208, residual contaminants are adsorbed using a dry scrubbing technique. For example, fluorine and other acid gases are significantly, if not completely, abated through use of dry scrubber canister 110 (FIG. 1).

A semiconductor fabrication tool may run a fabrication process, which is typically an ammonia or alkalide based process, for approximately 40-50 minutes, and then a tool cleaning process, which is typically acid based (e.g., HF), for approximately 20-30 minutes. The process of FIG. 2 can be used to abate the fabrication tool cleaning process. For example, the cleaning process within the fabrication tool may use C₂F₆ in the presence of a plasma, thus creating HF, fluorine and fluoride free radicals, which attack silicon deposited in the tool chamber. This cleaning process forms silicon tetrafluoride (SiF₆), and the waste gas stream that the system 100 receives contains silicon tetrafluoride and fluorine in a mixed-phase stream of solid and gas, along with PFCs such as C₂F₆.

At block 202, for example, in the thermal oxidation unit 102 (FIG. 1), the fluorine is thermally reacted to form HF, which is easier to scrub than fluorine. Additionally, most of the PFCs are burned. At block 204, for example, in the particulate remover 104 (FIG. 1), the process and system 100 are heavily loaded to remove a great deal of particulates from the fabrication tool cleaning process. Furthermore, at block 206, for example, in the packed column 108 (FIG. 1), the process and system 100 are again heavily loaded to remove HF and F₂ through absorption to water.

Once again, at block 208, residual contaminants are adsorbed using a dry scrubbing technique. For example, fluorine and other acid gases are significantly, if not completely, abated through use of dry scrubber canister 110 (FIG. 1).

The preceding is presented as an example of system 100 operation according to the process depicted in the flowchart of FIG. 2. However, use of embodiments of the invention does not require the particular waste gas stream components exemplified. The collective functionality of the components of system 100, and the sequence of reactions and operations that the components perform on a waste gas stream, provide an effective and efficient solution to a long-standing problem of waste gas treatment, that is, the abatement of dangerous substances from a waste gas stream.

### Extensions and Alternatives

Alternative embodiments of the invention are described throughout the foregoing description, and in locations that best facilitate understanding the context of the embodiments. Furthermore, the invention has been described with reference to specific embodiments thereof. It will, however, be evident that various modifications and changes may be made thereto without departing from the broader spirit and scope of the invention. For example, implementations were presented in which the waste gas stream that is undergoing abatement is output from a semiconductor fabrication tool. However, the techniques described herein are not limited to use with semiconductor fabrication tools and processes, for other tools and processes can benefit from the system and method described herein. Therefore, the specification and drawings are, accordingly, to be regarded in an illustrative rather than a restrictive sense.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

What is claimed is:

1. A system for abating dangerous substances from a waste gas stream, comprising:
a thermal oxidation unit configured to accept the waste gas stream;
a particulate remover unit directly coupled to the thermal oxidation unit;
a universal sump chassis directly coupled to the particulate remover unit;
a packed column directly coupled to the universal sump chassis; and
a dry scrub canister coupled to the packed column.

2. The system of claim 1, comprising:
a set of two or more thermal oxidation units, each thermal oxidation unit configured to accept injection of a different waste gas stream;
a set of two or more particulate remover units, each particulate remover unit being directly coupled to a thermal oxidation unit of the set of thermal oxidation units;
a universal sump chassis directly coupled to the set of particulate remover units;
a set of two or more packed columns directly coupled to the universal sump chassis; and
a dry scrub canister coupled to the set of packed columns.

3. The system of claim 2, wherein a first thermal oxidation unit is configured to accept a first waste gas stream that comprises a first gas and a second thermal oxidation unit is configured to accept a second waste gas stream that comprises a second gas, the first and second gases being substantially combustible when mixed.

4. The system of claim 3, wherein the universal sump is configured to accept the first waste gas stream from a first particulate remover unit of the set of particulate remover units and the second waste gas stream from a second particulate remover unit of the set of particulate remover units.

5. The system of claim 3, wherein the first waste gas stream is from a first semiconductor process and the second waste gas stream is from a second semiconductor process that is different than the first semiconductor process.

6. The system of claim 2, wherein the universal sump is configured to accept a first waste gas stream from a first particulate remover unit of the set of particulate remover units and a second waste gas stream from a second particulate remover unit of the set of particulate remover units.

7. The system of claim 6, wherein the set of packed columns is configured to accept waste gas streams, via passive distribution from the universal sump, wherein the waste gas streams comprise a mixture of the first and second waste gas streams.

8. The system of claim 1, wherein the thermal oxidation unit comprises one or more electric heaters.

9. The system of claim 8, wherein the thermal oxidation unit comprises a super-alloy metal tube, enshrouded by the one or more electric heaters, wherein the surface of the super-alloy metal is capable of operating at temperatures up to 1200° Celsius.

10. The system of claim 1, wherein the packed column is configured to accept, from the universal sump, a waste gas stream introduced at a lower end of the packed column to move upwardly through the packed column, and wherein the packed column is configured to accept introduction of a liquid at an upper location to move downwardly through a lower portion of the packed column.

11. The system of claim 10, wherein the packed column is configured to accept introduction of water at the upper location.

12. The system of claim 1, wherein the packed column comprises packing material, the packing material being a ceramic-based material.

13. The system of claim 1, wherein the dry scrubber is configured in the system such that it receives a semi-abated waste gas stream after the waste gas stream has moved through at least the thermal oxidation unit, the particulate remover, and the packed column.

14. The system of claim 1, wherein the waste gas stream is a semiconductor fabrication process waste gas stream.

15. A method for abating dangerous substances from a waste gas stream, comprising the steps of:
first, oxidizing combustible substances from the waste gas stream;
second, removing particulate-phase and water-soluble gas-phase components from the waste gas stream using a wet scrubbing technique;
third, absorbing acid gases from the waste gas stream using a counter-current packed column; and
last, adsorbing residual contaminants from the waste gas stream using a dry scrubbing technique that uses an adsorbent material.

16. A method for abating dangerous substances from a waste gas stream, the method comprising the steps of:
injecting the waste gas stream into a thermal oxidation stage, wherein the waste gas is mixed with an oxidizing gas stream to produce a first resultant gas;
moving the first resultant gas through a high-temperature reaction zone of the thermal oxidation stage, wherein particular components of the first resultant gas are combusted to produce a second resultant gas;
moving the second resultant gas to a particulate remover stage, wherein particulate phase components and a portion of water-soluble gas phase components of the second resultant gas are removed to produce a third resultant gas;
moving the third resultant gas to a sump stage, wherein the third resultant gas is mixed with a parallel gas stream from a parallel particulate remover stage to produce a fourth resultant gas, and wherein the fourth resultant gas is cooled as it migrates across a surface of a liquid;
passively distributing the fourth resultant gas to a column stage that includes a column that is packed with material, wherein water is introduced to absorb components of the fourth resultant gas to water, producing a water stream to carry away at least a corrosive substance and producing a fifth resultant gas;
moving the fifth resultant gas to a dry scrubber stage, wherein residual contaminants are removed from the fifth resultant gas using an adsorbent resin.

17. The method of claim 16, further comprising the step of:
injecting the oxidizing gas stream into the thermal oxidation stage such that turbulence is introduced to promote rapid mixing of the waste gas and the oxidizing gas.

18. The method of claim 17, further comprising the step of:
adjusting the amount of oxidizing gas injected into the thermal oxidation stage based on the composition of the waste gas.

19. The method of claim 16, wherein the particular components of the first resultant gas that are combusted include perfluorinated carbon compounds.

20. The method of claim 16, wherein components of the fourth resultant gas that are absorbed to water include hydrogen flouride.

21. The method of claim 16, further comprising the step of:
receiving the waste gas stream from a semiconductor fabrication tool.

22. An apparatus for abating toxic gases in a waste gas stream, the apparatus comprising:
means for oxidizing combustible substances from the waste gas stream;
means for next removing particulate-phase and water-soluble gas-phase components from the waste gas stream;
means for next absorbing acid gases from the waste gas stream; and
means for next adsorbing residual contaminants from the waste gas stream.

23. The apparatus of claim 22, further comprising:
means for mixing the waste gas stream with an oxidizing gas stream prior to oxidizing the combustible substances;
means for cooling and passively distributing the waste gas stream to the absorbing means;
means for precipitating the acid gases absorbed from the waste gas.
